(19) United States
(12) Patent Application Publication
(10) Pub. No.: US 2009/0115595 A1
(43) Pub. Date: May 7, 2009

(54) Automobile warning light improvement

(76) Inventor: David F. Black, Portage, IN (US)

Correspondence Address: David Black, 5241 Canterbury Ave., Portage, IN, 46368-6600, US

(21) Appl. No.: 11/639,165

(22) Filed: Dec. 15, 2006

Related U.S. Application Data
(60) Provisional application No. 60/831,246, filed on Jul. 17, 2006.

(51) Int. Cl. B60Q 1/44

(52) U.S. Cl. 340/479

(57) ABSTRACT

An improved system to produce the standard slowing, stopping, and being stopped signal and display it simultaneously and uniformly in all applicable rear-end signal lamps for vehicles is disclosed, which system includes connectivity to all rear end warning lights that are allocated for said purpose on vehicles, and which system includes the manner of switching these lamps on and off so that said switching manner lights these lamps according to their present manner of display but also when the vehicle begins slowing by the brake pedal being depressed or by any other means such as engine braking, air braking or the vehicle is actually in a condition of being stopped, by any means, these lamps remain on until the vehicle accelerates—except when in a reverse motion the lamps are not maintained on or activated by any other means than by the brake pedal having been depressed.

### FIELD OF THE INVENTION

This present invention relates generally to information indicating means for operating rear collision-avoidance warning lamps for vehicles and more particularly to circuit for the signal devices for vehicles responsive to driver intent and the motion condition of vehicles.

### BACKGROUND OF THE INVENTION

The message, that the signal devices on the rear-end of vehicles presently send through three rear-end display lamps according to its standard manner of display and standard operation for that display, concerns (1) slowing, stopping, and being stopped; (2) always being off when the vehicle is actually accelerating, either when going forward or in reverse; (3) being displayed with a steady-on lighting effect as opposed, for example, of a rapid on-and-off display of the lights; and (4) having all three lamps being activated simultaneously and uniformly. This standard manner of operation also allows the driver to activate the lamps to indicate both (1) his intent to slow and stop, and (2) the actual performance of the vehicle as slowing or being stopped.

However, only a brake-activated switch is used to produce this message. A brake activated switch can activate the lamps to indicate (1) a driver's intent to slow or stop, and (2) the vehicle's actual slowing, stopping, and being stopped only so long as it is activated. Once the brake activated switch is no longer activated while the vehicle may be slowing, stopping, or stopped, the former message can no longer be sent though it is still desirable, applicable, and mandated by law that the lamps send that message. Also if the brake activated switch is not activated during actual slowing, stopping, and being stopped, such as, but not limited to, with air-braking or with vehicles outfitted with manual transmissions, because the driver down-shifts the vehicle's transmission to slow his vehicle instead of braking with the foot-brake and thereby activating the brake switch, the driver is unable to send a slowing, stopping, or being stopped message.

Vehicles that no longer or are unable to send a slowing, stopping, or being stopped message, because of their reliance solely upon a brake-activated means, though they are slowing, stopping or stopped, are especially hazardous to following vehicles (1) during congested traffic where it is difficult to maintain the necessary distance between vehicles and rapid or unexpected de-acceleration frequently occurs and advanced warning is a necessity to make preventive maneuvers to avoid accidents, and (2) during periods of low visibility because of fog, snow, or rain where a following vehicle may be totally dependent on the lamp signal means that the lead vehicle sends to inform concerning the lead vehicle's motion, lack of motion, or position. A lead vehicle that does not send a slowing, stopping, or being stopped message under such adverse conditions can even cause multi-vehicle pile-ups when the lead driver, though stopped, takes his foot off the brake pedal, making his presence by his signal system no longer visible to a following vehicle.

This invention possesses numerous benefits and advantages by enabling the standard manner of display and standard operation on the rear-end of vehicles. This invention makes it possible that the message which the rear-end vehicle lamps send concerning slowing, stopping and being stopped indicates (1) the driver's intent to stop or slow, and (2) the vehicle's actual slowing, stopping, and being stopped, while never being activated when the vehicle is actually accelerating, either when going forward or in reverse. Thus this message ceases only when the vehicle actually accelerates—instead of ceasing to be sent when the brake pedal is no longer depressed, except in reverse. This invention then displays this fully enabled message simultaneously and uniformly in all three rear-end lamps (the two side lamps and the high mounted lamp). Importantly, this fully enabled message is sent irregardless of the drive's inability to send said message.

It is important that the message sent be uniform in all three lamps and not, for example, have the side lamps send a complete message and the high-mounted lamp send a partial message or even a different message. Sending different parts of the same message through different lamps (e.g., sending one message through the high-mounted lamp and another message through the side lamps) can have the following driver questioning which message is correct.

Thus, the configuration produced by this invention, not only supports the “standard operation” but also the uniform display of that operation thereby not impairing the message in any way and bringing the activation of the lamps into total compliance with the message required at all times to be sent while requiring no re-education for drivers concerning the nature of the message.

The configuration produced by this invention also makes it optionally possible to activate the third high mounted lamp along with the activation of the side lamps by the presence lamp switch. This effect is desirable since the triangular pattern produced by having any two lamps lit displays the vehicle's position upon the road.

### DESCRIPTION OF PRIOR ART

U.S. Pat. No. 3,364,384, issued on January 1968 to Dankert, discloses and is totally dependent upon a particular sensor used as a variable speed means, which sensor is no longer installable on present model vehicles since they lack a mechanical connection from the transmission to the speedometer. This sensor in conjunction with input from the brake pedal switch produces an output that lights only a rear window high-mounted lamp, which displays three different colors: with green for acceleration, yellow for deceleration, and red with the activation of the brake pedal switch. This system does not work in conjunction with the lower side lamps, which lack of uniformity causes confusion since it is sending a different signal than the side lamps. It also sends the same three colored signal when the vehicle is going in reverse as it sends when the vehicle is going forward. Thus, Dankert not only changes the nature of the message to be sent on the read end of vehicles but he does this in such a way as to cause confusion through the Christmas tree effect produced by the display of three different colored lights.

U.S. Pat. No. 4,922,225, issued on March 1987 to Dankert, discloses an electrical-mechanical deceleration switch. This switch, which is attached to the accelerator pedal, is used in conjunction with the input from the brake pedal switch, which brake pedal switch produces an output that is maintained and displayed only in the rear window high-mounted lamp until it is canceled by the switch attached to the accelerator pedal as the pedal is depressed. This system does not work in conjunction with the lower side lamps, which lack of uniformity causes confusion. This system, because it is dependent upon a mechanical deceleration switch, sends false messages: if the brake pedal is depressed and released the high mounted lamp will be maintained-on under the condition that the vehicle is accelerating down a decline. The system will also produce a false signal when the vehicle proceeds in reverse. When the vehicle is in reverse and the brake pedal is depressed, the high mounted lamp will remain lit so long as the vehicle is accelerating in reverse. Also the design of the accelerator pedal switch is such that it can mechanically jam and thereby cause the accelerator pedal to freeze in its position.

Others have suggested central light warning systems, including U.S. Pat. No. 3,364,384, issued on Jan. 16, 1968. That light included provision for signaling deceleration in only a high-mounted lamp. Other warning light systems are shown in U.S. Pat. Nos. 2,853,572; 3,105,884; 3,320,586; 3,336,450; 3,395,388; 3,414,879; 3,501,742; 3,806,870; 4,034,338; 4,149,141; 4,173,012; 4,224,598; 4,463,411; 4,470,036; 4,600,913; and 4,602,320. See also U.K. Patent 2,028,024 to H. Moffat and West German Patent 3,026,674 to Dietlicher. These units often employ a number of different colored lights for different situations. These units often send false signals or involve the problem of re-educating drivers in general to the meaning of their particular warning message. They also are objected to as being distracting. Often, fears of highways lighting up like Christmas trees flashing multicolored lights are stated as arguments against such systems.

### SUMMARY OF THE INVENTION

The present invention provides a system for simultaneously controlling all three rear-end warning lamps on vehicles, which system can light those lamps in all dangerous conditions in accordance with the nature of the message that they presently send so that they will respond or continue to respond to dangerous conditions while maintaining the warning lamps' essential function. The invention also provides for a monitor that optionally can be displayed on the instrument panel to make it possible to detect (in the same manner that one can detect the activation of turn signals) that the intended or actual response of the vehicle to dangerous conditions is being sent by said three rear-end warning lamps. A further improvement is provided for, which would be to have all three rear-end warning lamps on when activated by the presence lamp switch means.

The present invention encompasses a circuit, which may be a circuit as programmed, having output(s) and at least an acceleration signal, deceleration signal, brake signal, and reverse signal inputs, no matter how such inputs are obtained, which logic circuit develops, in conjunction with its inputs, outputs, when it receives input from any one or more of its inputs, so as to control said three rear-end warning lamps to be on under conditions of a deceleration (which may exclude deceleration in reverse) or a brake situation and so as also to activate optionally an instrument panel monitor,

The invention, together with the advantages thereof, may best be understood by reference to the following description, taken in connection with the accompanying drawings, in the several figures of which like reference numerals identify like elements.

### BRIEF DESCRIPTION OF THE DRAWINGS

FIG. 1 is a diagram of the information indicating means, with electrical processing unit 1 receiving input 2 from presence lamps switch means and input 3 from the brake pedal switch means and input 4 from a device which is immediately and accurately responsive to the motion condition of a vehicle and input 5 from the run electrical feed switch means and input 6 from transmission (which may be 6a park, 6b reverse, 6c neutral, or 6d forward output from the transmission means) and having output 7 which activates the high-mounted rear-end lamp and output 8 which activates the right rear-end side lamp and output 9 which activates the left rear-end side lamp and output 10 which activates instrument panel monitor.

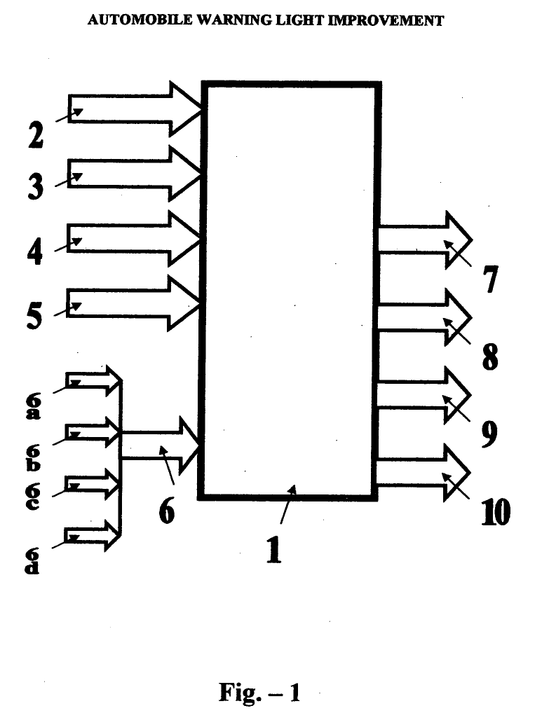

I claim:

1. A circuit, which may be a circuit as programmed and which may be a secondary circuit, for use in a vehicle having a conventional rear window-high “third” brake signal display lamp; side brake signal display lamps; a brake light control line; a reverse light control line; a brake pedal switch output means for energizing said brake signal display lamps; a run switch output means; a presence lamps switch output means; a variable speed means to register the motion condition of said vehicle, which is an electronic or electrical-mechanical output means; a park, forward, neutral, and reverse electrical means; which means may include a cruise control means; and an electrical energy source means, for converting any or all of said lamps to lamps which signal not only braking stopping, and being stopped but also, when not in reverse, at least deceleration, comprising:
a circuit, which may be a circuit as programmed, having output terminal(s) to said three brake signal display lamps and optional instrument panel monitor and inputs which may be directly or indirectly obtained and which inputs include a variable speed means input; a park, reverse, neutral and forward means input, a run switch input, a brake signal means input and a delaying input means; which inputs, when properly connected and when said inputs are energized, produce an output on said output terminal(s) so as to include but not be Limited to the following that:
when a reverse input is produced and a brake signal input is produced, said brake signal input is not maintained and produces an output on said output terminal(s);
and when a forward input is produced and when brake signal input is produced, said brake signal input is maintained and produces an output on said output terminal(s) until variable speed means input is greater than zero and thus increases;
and when a forward input or neutral input is produced and when variable speed means input is produced greater than zero and decreases, said variable speed means input is maintained and may or may not be delayed by a delaying input means before said variable speed means input produces or said delaying input means in turn produces an output on said output terminal(s) until variable speed means input is greater than zero and thus increases;
and when a forward input or neutral input is produced and when variable speed means input is zero, said speed means input is maintained and produces an output on said output terminal(s) until variable speed means input is greater than zero and thus increases;
and when a park input is produced and a run switch input is produced, an output is produced on said output terminal(s) and maintained until said run switch input means ceases.

2. The circuit of claim 1, which may be a circuit as programmed, wherein said circuit includes a presence lamp switch means input for converting all three said brake signal display lamps to lamps which signal vehicular presence comprising:
a circuit, which may be a circuit as programmed, having output terminal(s) to said three brake signal lamps and optional instrument panel monitor and inputs which may be directly or indirectly obtained and which inputs include a presence lamps switch means input; which input(s), when properly connected and when said input(s) is energized, produces an output on said output terminal(s) so as to include but not be limited to the following that:
when a presence lamps switch input(s) is produced, said presence lamps switch input produces an output on said output terminal(s).

3. A circuit, which may be a circuit as programmed, for a vehicle to indicate the presence condition of said vehicle having a conventional rear window-high “third” brake signal display lamp; side brake signal display lamps; a brake light control line, a presence lamp switch means, an electrical energy source means; for converting all three said brake signal display lamps to lamps which signal vehicular presence, comprising:
a circuit, which may be a circuit as programmed, having output terminal(s) to said three brake signal lamps and optional instrument panel monitor and inputs which may be directly or indirectly obtained and which inputs include a presence lamps switch means input; which input(s), when properly connected and when said input(s) is energized, produces an output on said output terminal(s) so as to include but not be limited to the following that:
when a presence lamps switch input(s) is produced, said presence lamps switch input produces an output on said output terminal(s).
